(19) United States
(12) Patent Application Publication
(10) Pub. No.: US 2019/0383247 A1
(43) Pub. Date: Dec. 19, 2019

(54) ULTRASONIC FUEL SUPPLYING APPARATUS AND INTERNAL COMBUSTION ENGINE AND COMBUSTION APPARATUS EMPLOYING THE SAME

(71) Applicant: Jung Keun LEE, Gimpo-si (KR)

(72) Inventors: Jung Keun LEE, Gimpo-si (KR); Jeong Ju KIM, Seoul (KR)

(21) Appl. No.: 16/553,953

(22) Filed: Aug. 28, 2019

Related U.S. Application Data
(63) Continuation-in-part of application No. PCT/KR2018/002393, filed on Feb. 27, 2018.

(30) Foreign Application Priority Data
Feb. 28, 2017 (KR) 10-2017-0026448
Feb. 28, 2017 (KR) 10-2017-0026502
Feb. 28, 2017 (KR) 10-2017-0026557
Feb. 27, 2018 (KR) 10-2018-0023385

(51) Int. Cl. F02M 27/08; B60K 15/03; B60K 15/077; B60K 15/06; F02M 37/00; F02M 37/04; F02M 43/04

(52) U.S. Cl. CPC F02M 27/08; B60K 15/03006; B60K 15/077; B60K 15/061; F02M 37/0023; F02M 37/0082; B60K 2015/03138; F02M 37/0088; F02M 43/04; B60K 2015/03217; B60K 2015/03256; B60K 2015/03243; B60K 2015/03144; F02M 37/04

(57) ABSTRACT

An ultrasonic fuel supplying apparatus includes an ultrasonic fuel tank including a fuel storing space for accommodating a fuel and a fuel atomizing space for accommodating an atomized fuel, an input pipe for supplying the fuel from an external main fuel tank to the ultrasonic fuel tank, at least one ultrasonic transducer arranged at a lower portion of the ultrasonic fuel tank and configured to atomize the fuel accommodated in the fuel storing space, an ultrasonic transducer controller configured to drive the at least one ultrasonic transducer, an output pipe for supplying atomized fuel from the ultrasonic fuel tank to an external fuel injection unit, and an output pipe extending unit extended from the output pipe into the fuel atomizing space and including an opening at a distal end.

### CROSS-REFERENCE TO RELATED APPLICATIONS

This application is a continuation-in-part of International Application No. PCT/KR2018/002393, filed Feb. 27, 2018, which is based upon and claims the benefit of priority from Korean Patent Application No. 10-2017-0026448, filed on Feb. 28, 2017, Korean Patent Application No. 10-2017-0026502, filed on Feb. 28, 2017, Korean Patent Application No. 10-2017-0026557, filed on Feb. 28, 2017, Korean Patent Application No. 10-2018-0023385, filed on Feb. 27, 2018, the contents of which are incorporated herein by reference in their entirety.

### BACKGROUND

### 1. Field

The present disclosure relates to an ultrasonic fuel supplying apparatus and an internal combustion engine and a combustion apparatus employing the same.

### 2. Description of the Related Art

The crude oil extracted from the underground mainly includes hydrocarbon, which is a mixture of various impurities including sulfur. The fractional distillation of the crude oil sequentially evaporates substances depending on the evaporation point, providing gasoline, kerosene, diesel oil, and fuel oil in order.

In general, the diesel oil has thermal efficiency higher than the gasoline by about 10%, which is mainly used for a diesel engine vehicle. However, as the diesel oil contains sulfur component, combustion of the diesel oil emits sulfur oxides, generating sulfuric acid by reacting with water vapor, which may affect human bodies.

A fuel line of a typical internal combustion engine includes a fuel pump for supplying a fuel from a fuel tank and a mixing device for mixing the fuel supplied by the fuel pump and air (oxygen) at a constant ratio. The fuel is supplied to a fuel filter from the fuel tank by the fuel pump, and after filtering impurities at the fuel filter, supplied to an injection pump. The injection pump applies a pressure to the fuel and injects the fuel into a cylinder via an injection valve.

The fuel injected into a cylinder of a diesel engine has better properties of evaporation and mixing with the air as a size of a fuel particle decreases, and therefore, the fuel needs to be atomized to a small particle.

KR Utility Model No. 20-1999-0041915, KR Pat. Appl. Laid-Open No. 10-2001-0025533, KR Pat. NO. 10-0840410, and KR Pat. Appl. Laid-Open No. 10-2012-0051462 describe An apparatus for supplying a fuel to an injector using an ultrasonic transducer to reduce an incomplete combustion of the fuel.

However, the descriptions of the above patent documents employ the fuel supplied from the fuel pump as a main fuel supply line and the fuel supplied through the ultrasonic transducer as an auxiliary fuel supply line, to achieve about 30% of increase in the fuel efficiency at maximum.

### SUMMARY

According to some embodiments of the present invention, an ultrasonic fuel supplying apparatus includes an ultrasonic fuel tank including a fuel storing space for accommodating a fuel and a fuel atomizing space for accommodating an atomized fuel, an input pipe for supplying the fuel from an external main fuel tank to the ultrasonic fuel tank, at least one ultrasonic transducer arranged at a lower portion of the ultrasonic fuel tank and configured to atomize the fuel accommodated in the fuel storing space, an ultrasonic transducer controller configured to drive the at least one ultrasonic transducer, an output pipe for supplying atomized fuel from the ultrasonic fuel tank to an external fuel injection unit, and an output pipe extending unit extended from the output pipe into the fuel atomizing space and including an opening at a distal end.

According to some embodiments of the present invention, an internal combustion engine includes a main fuel tank for storing a fuel, a fuel pump coupled to the main fuel tank, an ultrasonic fuel supplying apparatus according to some embodiments of the present invention, a fuel injection unit configured to supply the fuel from the fuel pump and the atomized fuel from the ultrasonic fuel supplying apparatus to a cylinder chamber, and a drive unit configured to drive using the fuel supplied by the fuel injection unit.

According to some embodiments of the present invention, a combustion apparatus includes a main fuel tank for storing a fuel, an ultrasonic fuel supplying apparatus according to some embodiments of the present invention, a fuel injection unit configured to supply the fuel from the main fuel tank and the atomized fuel from the ultrasonic fuel supplying apparatus into a combustion chamber, and a combusting unit configured to combust the fuel and the atomized fuel supplied by the fuel injection unit in the combustion chamber.

Although the respective embodiments are described herein independently, the embodiments can be mutually combined, and the combined embodiments are also included in the scope of the present invention.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a block diagram of an internal combustion engine according to some embodiments of the present invention;

FIG. 2 is a schematic diagram of an ultrasonic fuel supplying apparatus according to some embodiments of the present invention;

FIG. 3 is a schematic diagram of a fuel level control unit according to some embodiments of the present invention, including a fuel level control valve;

FIG. 4 is a schematic diagram of a fuel level control unit according to some embodiments of the present invention, including a fuel gauge, a valve, and a valve controller;

FIG. 5 is a schematic diagram of a fuel level control unit according to some embodiments of the present invention, including a level control fuel tank, a fuel gauge, a valve, and a valve controller;

FIGS. 6A and 6B are schematic diagrams of an air intake port according to some embodiments of the present invention;

FIGS. 7A and 7B are schematic diagrams of an output pipe extending unit according to some embodiments of the present invention;

FIG. 8 is an image of a prototype ultrasonic fuel supplying apparatus; and

FIG. 9 is a block diagram of a combustion apparatus according to some embodiments of the present invention.

### DETAILED DESCRIPTION OF THE PREFERRED EMBODIMENTS

Exemplary embodiments of the present disclosure are described in detail below with reference to the accompanying drawings.

In the case of a diesel engine, in order to increase the fuel efficiency by about 30% or more, it is necessary to drive an engine using the atomized fuel by way of the ultrasonic transducer as a main fuel supply line or using the atomized fuel only in a normal RPM region used in everyday life (for example, equal to or lower than about 3000 rpm).

In addition, in order to efficiently reduce the fuel consumption and to efficiently suppress a generation of the harmful exhaust gas in a combustion apparatus such as boiler, heater, electric generator using kerosene, diesel oil, heavy oil, and the like, it is necessary to operate the combustion apparatus using the atomized fuel as a main fuel supply line or using the atomized fuel only.

In order to at least partially solve the above problems, it is an object of the present invention to provide an ultrasonic fuel supplying apparatus capable of atomizing the fuel using an ultrasonic transducer and driving or operating an internal combustion engine or a combustion apparatus using the atomized fuel as a main fuel supply line or using the atomized fuel only.

It is another object of the present invention to provide an internal combustion engine or a combustion apparatus employing the ultrasonic fuel supplying apparatus.

Although a diesel engine for a vehicle using the diesel oil is exemplified as an internal combustion engine, the present invention is not limited to this, but can be applied to any internal combustion engine using a fuel having the evaporation point of 150 degrees Celsius (for example, kerosene, diesel oil, heavy oil, and the like) and any combustion apparatus using such fuel, such as boiler, heater, electric generator, and the like.

Further, the present invention can be applied regardless of a type of the combustion chamber of the internal combustion engine (for example, direct injection and indirect injection), a type of the fuel injection pump (for example, inline injection pump, distributor injection pump), unit injector, and the like), and a type of the fuel injection (for example, mechanical type, electronic control type, and the like).

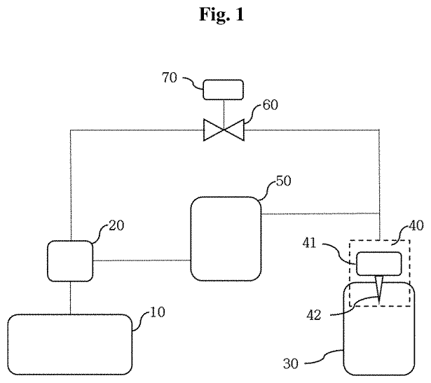

FIG. 1 is a block diagram of a diesel engine as an example of an internal combustion engine according to some embodiments of the present invention.

As shown in FIG. 1, the internal combustion engine according to some embodiments of the present invention includes a main fuel tank 10, a fuel pump 20 coupled to the main fuel tank 10, a fuel injection unit 40 for supplying the fuel from the fuel pump 20 to a cylinder chamber 30, an ultrasonic fuel supplying apparatus 50 for atomizing the fuel and supplying an atomized fuel, a valve 60 coupled between the fuel pump 20 and the fuel injection unit 40 to switch on and off the fuel supply from the fuel pump 20 to the fuel injection unit 40, and a valve controller 70 for controlling open and close of the valve 60.

In FIG. 1, a fuel collection line of a typical diesel engine is not shown, but only a fuel supply line is shown.

In some embodiments of the present invention, the fuel accommodated in the main fuel tank 10 is supplied to the fuel injection unit 40 via a first fuel supply line in which the fuel is pumped by the fuel pump 20 and directly supplied to the cylinder chamber 30 in a liquid state and a second fuel supply line in which the fuel is atomized by the ultrasonic fuel supplying apparatus 50 and supplied to the cylinder chamber 30 in a gas state.

In some embodiments of the present invention, the fuel supply via the second fuel supply line is always in an open stage (100% ON), while the fuel supply via the first fuel supply line is in an open state (100% ON), a close state (0% ON), or a partially open state (between 0% and 100%) depending on an operation status of the internal combustion engine, which is a sort of hybrid mode.

The fuel injection unit 40 includes an injection pump 41 and an injection nozzle 42. The fuel supplied to the fuel injection unit 40 via the first fuel supply line, the second fuel supply line, or both is injected into the cylinder chamber 30 through the injection nozzle 42 by the injection pump 41. As typical devices and structures can be used for a fuel filter for removing impurities from the fuel and a mixing device for mixing the air taken from an air cleaner with the injected fuel, these devices are omitted from drawing and detailed descriptions thereof are also omitted.

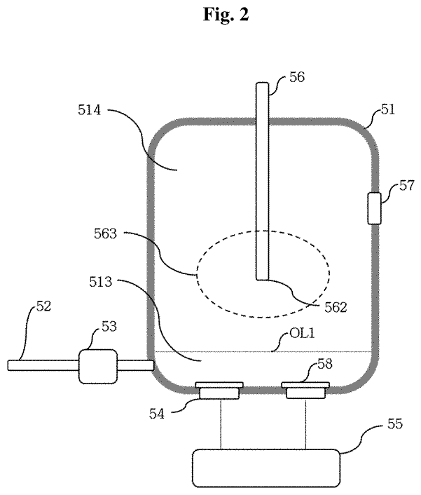

FIG. 2 is a schematic diagram of the ultrasonic fuel supplying apparatus 50.

As shown in FIG. 2, the ultrasonic fuel supplying apparatus 50 includes a ultrasonic fuel tank 51 including a fuel storing space 513 and a fuel atomizing space 514, an input pipe 52 for supplying the fuel from the main fuel tank 10 to the ultrasonic fuel tank 51 via the fuel pump 20, a fuel level control unit 53 arranged between the input pipe 52 and the ultrasonic fuel tank 51 for maintaining the amount of the fuel accommodated in the fuel storing space 513, at least one ultrasonic transducer 54 arranged at the lower portion (bottom) of the ultrasonic fuel tank 51 for atomizing the fuel accommodated in the fuel storing space 513, an ultrasonic transducer controller 55 for driving the ultrasonic transducer 54, an output pipe 56 for supplying the fuel atomized by the ultrasonic transducer 54 to the fuel injection unit 40, and an air intake port 57 for injecting the air from the outside into the ultrasonic fuel tank 51 when a pressure inside the ultrasonic fuel tank 51 is decreased as the atomized fuel is supplied to the fuel injection unit 40 through the output pipe 56.

An oscillating plate 58 is arranged on the bottom of the ultrasonic fuel tank 51, and the ultrasonic transducer 54 is attached to the back of the oscillating plate 58. Typical piezoelectric ceramics can be used for the ultrasonic transducer 54. When a current is applied to the ultrasonic transducer 54, the oscillating plate 58 makes an oscillation, which generates ultrasonic waves to cause an oscillation in the fuel.

That is, when the electric power is supplied to the ultrasonic transducer 54 by the ultrasonic transducer controller 55, the ultrasonic transducer 54 causes the oscillation from the bottom of the fuel. Such oscillation causes molecules of the fuel to collide each other to transfer the oscillation among the molecules, and when the oscillation reaches the surface of the fuel, fuel particles on the surface of the fuel are emitted from the surface in a fine particle state. Therefore, when the depth of the fuel is too deep or too shallow, the fuel cannot be efficiently atomized. In addition, in order to secure the atomized fuel, the fuel atomizing space 514 needs to be a few times or more of the fuel storing space 513 in volume.

In this manner, as the atomization amount by the ultrasonic transducer 54 depends on the fuel level (that is, the height OL1 from the bottom to the surface of the fuel), it is required to maintain a proper level of the fuel accommodated in the fuel storing space 513. In the case of an ultrasonic transducer used in a typical humidifier, a proper height from the bottom to the surface of the water is about 20 mm to 50 mm, and the atomization amount in this case is about 200 ml to 500 ml per hour.

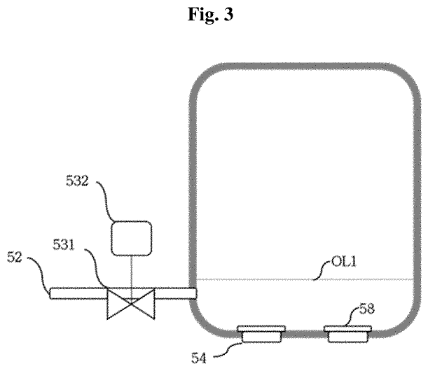

FIG. 3 is a schematic diagram of the fuel level control unit 53 for maintaining the fuel level in the ultrasonic fuel tank 51 of the ultrasonic fuel supplying apparatus 50 according to some embodiments of the present invention, including a fuel level control valve.

As shown in FIG. 3, in some embodiments of the present invention, the fuel level control unit 53 includes a valve 531 for controlling an amount of supplying the fuel and a valve controller 532 for controlling the opening amount of the valve 531.

As described above, in order to achieve an enough atomization of the fuel using the ultrasonic transducer 54, a proper height OL1 from the bottom to the surface of the fuel needs to be maintained. In some embodiments of the present invention, the opening amount of the valve 531 is controlled by the valve controller 532 such that the fuel is supplied from the fuel pump 20 by the amount atomized and consumed in the cylinder chamber 30. In some embodiments of the present invention, the valve 531 is always opened by a few millimeters using a manual valve switch (not shown) instead of using the valve controller 532 such that the fuel is supplied from the fuel pump 20 into the ultrasonic fuel tank 51 by the amount of the atomized fuel supplied to the cylinder chamber 30.

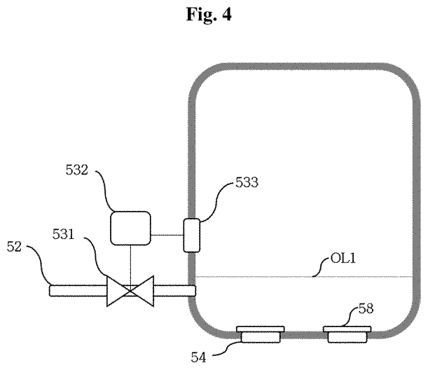

FIG. 4 is a schematic diagram of the fuel level control unit 53 for maintaining the fuel level in the ultrasonic fuel tank 51 of the ultrasonic fuel supplying apparatus 50 according to some embodiments of the present invention, including a fuel gauge, a valve, and a valve controller.

As shown in FIG. 4, in some embodiments of the present invention, the fuel level control unit 53 includes a valve 531 for controlling the amount of supplying the fuel, a valve controller 532 for controlling the opening amount of the valve 531, and a fuel gauge 533 for detecting the height OL1 of the surface of the fuel.

In some embodiments of the present invention, the fuel gauge 533 detects the height OL1 of the surface of the fuel (i.e., the fuel level) indicating the amount of the fuel in the ultrasonic fuel tank 51, and outputs a detection result to the valve controller 532. Upon receiving the detection result from the fuel gauge 533, the valve controller 532 compares the height OL1 of the surface of the fuel detected by the fuel gauge 533 with a predetermined value and controls the opening amount of the valve 531 based on a result of the comparison. That is, when the result of the comparison says that the detected height OL1 of the surface of the fuel is larger than the predetermined value, the valve controller 532 closes the valve 531 to reduce or cut the fuel supplied to the ultrasonic fuel tank 51. On the contrary, when the result of the comparison says that the detected height OL1 of the surface of the fuel is smaller than the predetermined value, the valve controller 532 opens the valve 531 to start or increase the fuel supplied to the ultrasonic fuel tank 51.

When detecting the height OL1 of the surface of the fuel in the ultrasonic fuel tank 51 by the fuel gauge 533 while the internal combustion engine is being driven, the height OL1 of the surface of the fuel may randomly fluctuate due to the oscillation of the ultrasonic transducer 54 and the vibration caused by the driving of the internal combustion engine (for example, running of a vehicle driven by the internal combustion engine (diesel engine) according to some embodiments of the present invention).

For this reason, in some embodiments of the present invention, the fuel gauge 533 divides time sectors, obtains an average value of the height OL1 in each time sector, and outputs the average value of the height OL1 to the valve controller 532. In some embodiments of the present invention, the valve controller 532 divides time sectors and obtains an average value of the height OL1 inputted from the fuel gauge 533 in each time sector, to reduce an error caused by the random fluctuation of the height OL1.

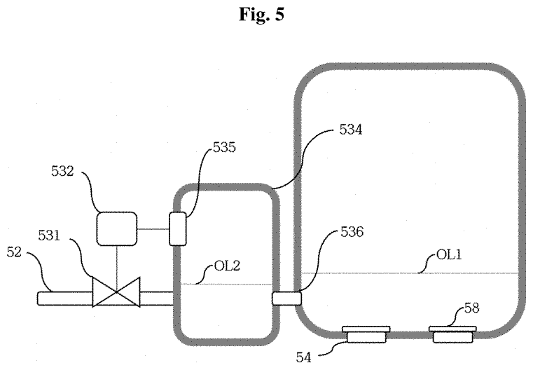

FIG. 5 is a schematic diagram of the fuel level control unit 53 for maintaining the fuel level in the ultrasonic fuel tank 51 of the ultrasonic fuel supplying apparatus 50 according to some embodiments of the present invention, including a level control fuel tank, a fuel gauge, a valve, and a valve controller.

As shown in FIG. 4, in some embodiments of the present invention, the fuel level control unit 53 includes a valve 531 for controlling the amount of supplying the fuel, a valve controller 532 for controlling the opening amount of the valve 531, a level control fuel tank 534, and a fuel gauge 535 for detecting a height OL2 of the surface of the fuel in the level control fuel tank 534.

As described above, while the internal combustion engine is being driven, the height OL1 of the surface of the fuel randomly fluctuates due to eruptions of the surface of the fuel caused by the oscillation of the ultrasonic transducer 54 and vibrations caused by the driving of the internal combustion engine. In some embodiments of the present invention, the fuel level in the ultrasonic fuel tank 51 is more efficiently controlled using the level control fuel tank 534 that is separately provided.

As shown in FIG. 5, the level control fuel tank 534 is coupled to the ultrasonic fuel tank 51 with a connection pipe 536 and disposed such that the height OL1 of the surface of the fuel in the ultrasonic fuel tank 51 and the height OL2 of the surface of the fuel in the level control fuel tank 534 become substantially same each other. Therefore, when the height OL1 changes due to increase or decrease of the fuel in the ultrasonic fuel tank 51, this causes the height OL2 of the surface of the fuel in the level control fuel tank 534 to be changed in the same manner. This makes it possible to control the fuel level of the ultrasonic fuel tank 51 by detecting the height OL2 of the surface of the fuel in the level control fuel tank 534.

As the eruptions of the surface of the fuel due to the oscillation of the ultrasonic transducer 54 may affect the detection of the height OL1 more than the fluctuation due to the running of the vehicle, the fuel level in the ultrasonic fuel tank 51 can be controlled more efficiently by using the level control fuel tank 534 that is separately provided and receives less influence by the oscillation of the ultrasonic transducer 54.

The fuel gauge 535 detects the height OL2 of the surface of the fuel in the level control fuel tank 534 and outputs a result of the detection to the valve controller 532. Upon receiving the detection result from the fuel gauge 535, the valve controller 532 compares the height OL2 detected by the fuel gauge 535 with a predetermined value and controls the opening amount of the valve 531 based on a result of the comparison. That is, when the result of the comparison says that the detected height OL2 of the surface of the fuel is larger than the predetermined value, the valve controller 532 closes the valve 531 to reduce or cut the fuel supplied to the ultrasonic fuel tank 51. On the contrary, when the result of the comparison says that the detected height OL2 of the surface of the fuel is smaller than the predetermined value, the valve controller 532 opens the valve 531 to start or increase the fuel supplied to the ultrasonic fuel tank 51.

In order to improve the accuracy also in this case, the fuel gauge 535 divides time sectors, obtains an average value of the height OL1 in each time sector, and outputs the average value of the height OL2 to the valve controller 532, or the valve controller 532 divides time sectors and obtains an average value of the height OL2 inputted from the fuel gauge 535 in each time sector, to reduce an error caused by the random fluctuation of the height OL2.

An oil gauge, a float switch, or the like can be used for the fuel gauges 533 and 535.

When the ultrasonic transducer 54 is operated in a state in which the fuel in the ultrasonic fuel tank 51 runs out so that the bottom of the ultrasonic transducer 54 is exposed, a bonding portion is peeled off leading to a malfunction. In order to avoid this kind of situation, in some embodiments of the present invention, the amount of the fuel in the ultrasonic fuel tank 51 is constantly monitored using the fuel gauge 533 or 535. When it is determined that the fuel in the ultrasonic fuel tank 51 runs out, the ultrasonic transducer controller 55 stops the operation of the ultrasonic transducer 54.

When a result of the monitoring received from the fuel gauge 533 or 535 is lower than a predetermined amount, the ultrasonic transducer controller 55 determines that the fuel in the ultrasonic fuel tank 51 is fully consumed. In such a case, the ultrasonic transducer controller 55 outputs an alarm to prompt a driver to remove a cause or to output a signal for causing the valve controller 532 to immediately open the valve 531 to supply the fuel into the ultrasonic fuel tank 51.

Upon driving an internal combustion engine (for example, a diesel engine) employing the ultrasonic fuel supplying apparatus 50 according to some embodiments of the present invention, depending on the stroke of the combustion process, the atomized fuel in the ultrasonic fuel supplying apparatus 50 is drawn into the cylinder chamber 30. This causes the pressure inside the ultrasonic fuel tank 51 to be lower than the atmospheric pressure, generating a phenomenon that a wall of the ultrasonic fuel tank 51 is inwardly shrunken. For this reason, the air from the outside needs to be injected into the ultrasonic fuel tank 51 as appropriate, in order to maintain the normal pressure (atmospheric pressure) inside the ultrasonic fuel tank 51, even when the atomized fuel in the ultrasonic fuel tank 51 is drawn into the cylinder chamber 30.

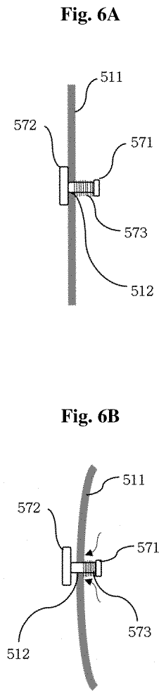

FIGS. 6A and 6B are schematic diagrams of the air intake port 57 according to some embodiments of the present invention.

As shown in FIGS. 6A and 6B, an air inlet 512 having a predetermined size is formed on a wall 511 of the ultrasonic fuel tank 51. The air intake port 57 includes a pin 571 slidably inserted into the air inlet 512, a caulking member 572 attached at a first end of the pin 571, and a spring (elastic member) 573 into which the pin 571 is slidably inserted so that the spring 573 is so that the spring 573 is arranged between a second end of the pin 571, which is on the opposite side of the first end, and the wall 511 to provide a tension to the second end of the pin 571 exerting outwards. The second end of the pin 571 has a rivet head shape, so that the first end of the pin 571 is inserted through the spring 573, and in this state, after inserting the first end of the pin 571 into the air inlet 512, the first end of the pin 571 and the caulking member 572 are attached to each other. In this manner, the spring 573 is elastically fixed between the second end of the pin 571 and the wall 511 with a predetermined initial tension.

The diameter of the air inlet 512 is set smaller than the diameter of the spring 573 and the diameter of the spring 573 is set smaller than the diameter of the second end of the pin 571. In order for the pin 571 to travel back and forth inside the air inlet 512 and to allow the air flows between the outer circumference of the pin 571 and the inner wall of the air inlet 512, the diameter of the air inlet 512 is set larger than the diameter of the body of the pin 571.

Therefore, in a state in which the pin 571 is inserted through the spring 573, the pin 571 is inserted into the air inlet 512, and then, in a state in which the spring 573 is slightly compressed, the first end of the pin 571 and the caulking member 572 are attached to each other with the caulking member 572 making contact with the wall 511 from the inside. In this state, the tension of the spring 573 causes the caulking member 572 to be pulled towards the wall 511, achieving a tight contact between the caulking member 572 and the wall 511.

As shown in FIG. 6A, when the pressure inside the ultrasonic fuel tank 51 is the normal pressure (atmospheric pressure), the air intake port 57 is sealed by the tension of the spring 573, which causes the caulking member 572 to have tight contact with the inner wall of the wall 511. Therefore, in this state, the air cannot travel through the air inlet 512.

When the atomized fuel in the ultrasonic fuel supplying apparatus 50 is drawn into the cylinder chamber 30 due to a driving of the internal combustion engine so that the pressure inside the ultrasonic fuel tank 51 decreases, As shown in FIG. 6B, the wall 511 of the ultrasonic fuel tank 51 shrinks inwards due to the outside atmospheric pressure.

When the pressure inside the ultrasonic fuel tank 51 is low enough to cause a force for pulling the caulking member 572 inwards to exceed the tension of the spring 573, As shown in FIG. 6B, the caulking member 572 is pulled inwards so that the air from the outside is injected into a space between the air inlet 512 and the pin 571.

When the injection of the air is enough to cause the pressure inside the ultrasonic fuel tank 51 to be back to the normal pressure, the tension of the spring 573 pulls the caulking member 572 towards the wall 511 so that the caulking member 572 makes contact with the wall 511 of the ultrasonic fuel tank 51 and the air inlet 512 is sealed with the caulking member 572.

Although the spring 573 is used as an example of the elastic member for providing the tension in the above embodiment, the present invention is not limited to this, but materials such as rubber, silicone, or the like having elasticity or a solenoid can be used as the elastic member.

In an apparatus for atomizing the fuel using the ultrasonic wave, the oscillation frequency of the ultrasonic transducer and the fuel level (depth of the fuel in which the ultrasonic transducer is submerged) greatly affects the amount of the atomization. For example, even when the same frequency is used, the atomization depends on the fuel level. For this reason, in some embodiments of the present invention, the fuel level in the ultrasonic fuel tank 51 is maintained in a predetermined range using the fuel level control unit 53.

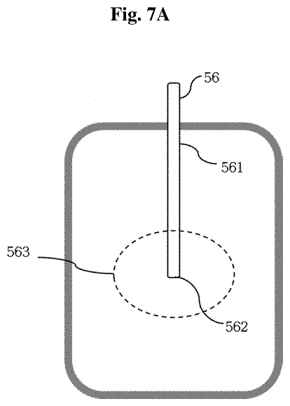

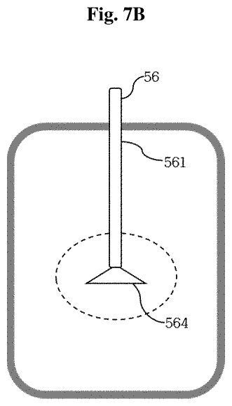

In the ultrasonic fuel supplying apparatus 50, a fuel pillar is formed right above the ultrasonic transducer 54 in a direction perpendicular to a plane of the ultrasonic transducer 54, and the emitted particles form a high density area 563 of the atomized fuel right above the fuel pillar (see FIGS. 7A and 7B). In some embodiments of the present invention, a distal end of the output pipe 56 is extended into the high-density area 563 of the fuel in the ultrasonic fuel tank 51 to supply the atomized fuel in a more efficient manner.

FIGS. 7A and 7B are schematic diagrams of an output pipe extending unit 561 according to some embodiments of the present invention.

As shown in FIG. 7A, the ultrasonic fuel supplying apparatus 50 according to some embodiments of the present invention includes the output pipe extending unit 561 extended from the output pipe 56 into the ultrasonic fuel tank 51. An opening 562 is formed at a distal end of the output pipe extending unit 561, and the length of the output pipe extending unit 561 is set such that the opening 562 is positioned in the high density area 563 of the atomized fuel (for example, around the center of the ultrasonic fuel tank 51).

Further, the air intake port 57 is arranged at the wall 511 of the ultrasonic fuel tank 51 at a position higher than the opening 562 of the output pipe extending unit 561. When the air is injected into the ultrasonic fuel tank 51, the injected air may cause a perturbation inside the ultrasonic fuel tank 51. By setting the position of the air intake port 57 higher than the opening 562 of the output pipe extending unit 561, the area around the opening 562 where the atomized fuel is drawn into the output pipe 56 can experience less influence of the injected air.

As shown in FIG. 7B, in some embodiments of the present invention, the output pipe extending unit 561 includes a funnel-shaped opening 564 at its distal end. With this structure, the area for drawing the atomized fuel can be enlarged in the high-density area 563, which makes it possible to supply the atomized fuel to the cylinder chamber 30 in a more efficient manner.

A prototype of the ultrasonic fuel supplying apparatus 50 was actually manufactured and applied to a diesel engine of a vehicle. A result of an experiment confirmed that the diesel engine was driven only with the atomized fuel supplied from the ultrasonic fuel supplying apparatus 50 according to some embodiments of the present invention in an RPM region that is used in the everyday life (equal to or lower than about 3,000 rpm) or when driving the vehicle at a constant speed with the engine RPM lower than 3,000 rpm.

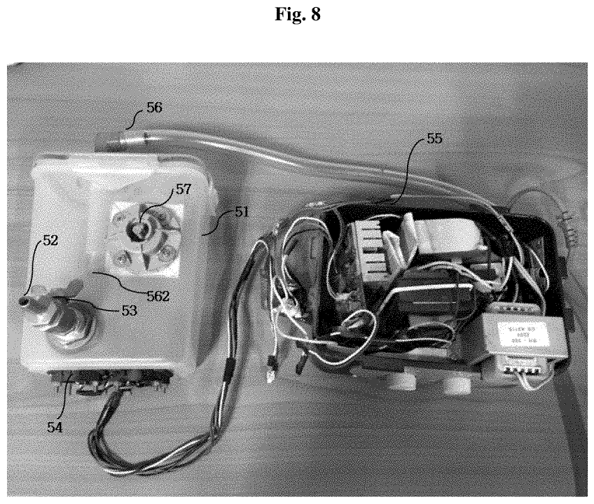

FIG. 8 is an image of a prototype of the ultrasonic fuel supplying apparatus 50 actually manufactured for the experiment.

A plastic container having a size of 14 cm×18 cm×9 cm (width×height×depth) was used for the ultrasonic fuel tank 51. As the ultrasonic transducer 54, a TDK ultrasonic transducer with a controller was used, which produces the atomization amount of about 200 ml per hour with the particle size of about 3 μm to 4 μm. Only a valve with the valve controller was used for the fuel level control unit 53 with the opening of the valve about 1 mm to 2 mm fixed. The fuel level from the bottom to the surface of the fuel was set to about 20 mm and constantly maintained. A total of four ultrasonic transducers were installed at the bottom of the plastic container, and the number of which was set ultrasonic transducers was set to be adjusted as appropriate in an actual operation. FIG. 8 is a picture of the ultrasonic fuel supplying apparatus 50 actually manufactured in the above manner.

The ultrasonic fuel supplying apparatus 50 manufactured in the above manner was applied to a diesel engine of a 1993 Hyundai Galloper to perform an engine driving experiment. The Galloper is a sports utility vehicle equipped with a 2.5 L (2,476 cc) diesel engine, which is a 4×4 vehicle with a manual five-speed transmission. The type of the engine is D4BX using the diesel with the maximum output of 73/4,200 ps/rpm, maximum torque of 14.9/2,500 kg*m/rpm, and the fuel efficiency of 17.3 km/l in the specification.

A fuel supply pipe connecting a fuel pump and an injection pump was cut, the pipe on the fuel pump side was connected to the input pipe 52 of the ultrasonic fuel supplying apparatus 50, and the pipe on the injection pump side was connected to the output pipe 56 of the ultrasonic fuel supplying apparatus 50. The fuel was supplied to the ultrasonic fuel tank 51 to set the fuel level to 25 mm. The fuel was atomized by oscillating the ultrasonic transducer 54 via the ultrasonic transducer controller 55, and then the engine started, and the accelerator was controlled to change the engine RPM.

The result of the experiment confirmed that, by atomizing the fuel of about 400 ml per hour using two ultrasonic transducers, without using the first fuel supply line that directly supplies the fuel from the main fuel tank 10 to the fuel injection unit 40 via the fuel pump 20, the engine was driven for about an hour using the second fuel supply line only in which the atomized fuel was supplied from the ultrasonic fuel supplying apparatus 50 to the fuel injection unit 40 while randomly changing the engine RPM below 3,000 rpm.

When the engine starts or when the engine RPM exceeds 3,000 rpm, the fuel density of the atomized fuel may not be enough. In some embodiments of the present invention, the internal combustion engine employing the ultrasonic fuel supplying apparatus 50 includes the valve 60 arranged between the fuel pump 20 and the fuel injection unit 40 to switch ON and OFF the fuel supply from the fuel pump 20 and the valve controller 70 for controlling the valve 60.

As shown in FIG. 8, the air intake port 57 is arranged at a position higher than the opening 562 of the output pipe extending unit 561. When the air is injected into the ultrasonic fuel tank 51, the injected air may cause a perturbation inside the ultrasonic fuel tank 51. By setting the position of the air intake port 57 higher than the opening 562 of the output pipe extending unit 561, the area around the opening 562 where the atomized fuel is drawn into the output pipe 56 can experience less influence of the injected air.

As described above, according to some embodiments of the present invention, by driving an engine using the atomized fuel supplied from the ultrasonic fuel supplying apparatus 50 as the main fuel supply line or using the atomized fuel only in the RPM region used in the everyday life (hybrid mode), it is possible to greatly increase the fuel efficiency and to efficiently suppress the harmful exhaust gas.

In some embodiments of the present invention, using the atomized fuel supplied from the ultrasonic fuel supplying apparatus 50 as the main fuel supply line means that a proportion of the fuel supply from the fuel pump 20 (first fuel supply line) is equal to or less than 49% of the total fuel supply and a proportion of the atomized fuel supply from the ultrasonic fuel supplying apparatus 50 (second fuel supply line) is equal to or more than 51% of the total fuel supply.

In some embodiments of the present invention, using the atomized fuel supplied from the ultrasonic fuel supplying apparatus 50 as the main fuel supply line means that a proportion of the fuel supply from the fuel pump 20 (first fuel supply line) is equal to or less than 19% of the total fuel supply and a proportion of the atomized fuel supply from the ultrasonic fuel supplying apparatus 50 (second fuel supply line) is equal to or more than 81% of the total fuel supply.

In some embodiments of the present invention, using the atomized fuel supplied from the ultrasonic fuel supplying apparatus 50 only means that the fuel supply from the fuel pump 20 (first fuel supply line) is cut (0%) so that the atomized fuel supply from the ultrasonic fuel supplying apparatus 50 (second fuel supply line) takes 100% of the total fuel supply.

Although a diesel engine is used as an example of the internal combustion engine employing the ultrasonic fuel supplying apparatus according to some embodiments of the present invention, the present invention is not limited to this, but can be applied to any internal combustion engine using a fuel having the evaporation point of 150 degrees Celsius (for example, kerosene, diesel oil, heavy oil, and the like) and any combustion apparatus using such fuel, such as boiler, heater, electric generator, and the like.

In the case of an internal combustion engine or a combustion apparatus employing a specific start mechanism, it is possible to use the second fuel supply line only without using the first fuel supply line even at the time of starting the internal combustion engine or the combustion apparatus

Although the high RPM region is described to be an RPM region of equal to or higher than 3,000 rpm in the specification, this value can be changed depending on the type and the specification of the engine.

Further, various controllers for controlling various valves and ultrasonic transducers can be separately provided or can be integrated into an electronic control device such as an engine control unit (ECU) or an engine control module (ECM).

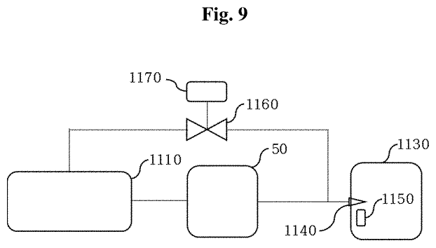

FIG. 9 is a block diagram of a combustion apparatus according to some embodiments of the present invention.

As shown in FIG. 9, the combustion apparatus according to some embodiments of the present invention includes a main fuel tank 1110 for accommodating a fuel, a fuel injection unit 1140 for supplying the fuel from the main fuel tank 1110 to a combustion chamber 1130, the ultrasonic fuel supplying apparatus 50 for atomizing the fuel and supplying an atomized fuel, a combusting unit 1150 for combusting the fuel in the combustion chamber 1130, a valve 1160 arranged between the main fuel tank 1110 and the fuel injection unit 1140 for switching ON and OFF the fuel supply from the main fuel tank 1110, and a valve controller 1170 for controlling the valve 1160.

A pump or a fan for sending the fuel from the main fuel tank 1110 to the combustion chamber 1130 or the atomized fuel from the ultrasonic fuel supplying apparatus 50 to the combustion chamber 1130 can be arranged at a proper position as appropriate.

Similar to the internal combustion engine, in the case of the combustion apparatus, the fuel accommodated in the main fuel tank 1110 is supplied to the combustion chamber 1130 via a first fuel supply line in which the fuel is directly supplied to the fuel injection unit 1140 in a liquid state and a second fuel supply line in which the fuel is atomized by the ultrasonic fuel supplying apparatus 50 and supplied to the fuel injection unit 1140 in an atomized state.

In the case of the combustion apparatus, by using the atomized fuel from the start to the normal operation status as the main fuel supply line or operating the combustion apparatus using the atomized fuel only, it is possible to greatly increase the fuel efficiency and to efficiently suppress the harmful exhaust gas.

As described above, according to some embodiments of the present invention, an ultrasonic fuel supplying apparatus capable of atomizing the fuel using an ultrasonic transducer and driving or operating an internal combustion engine or a combustion apparatus using the atomized fuel as a main fuel supply line or using the atomized fuel only can be provided.

Further, according to some embodiments of the present invention, the fuel consumption can be efficiently reduced and the harmful exhaust gas can be efficiently suppressed an internal combustion engine or a combustion apparatus using kerosene, diesel oil, heavy oil, and the like

The present disclosure should not be limited to these embodiments but various changes and modifications are made by one ordinarily skilled in the art within the subject matter, the spirit and scope of the present disclosure as hereinafter claimed. Specific terms used in this disclosure and drawings are used for illustrative purposes and not to be considered as limitations of the present disclosure. Exemplary embodiments of the present disclosure have been described for the sake of brevity and clarity. Accordingly, one of ordinary skill would understand the scope of the claimed invention is not to be limited by the explicitly described above embodiments but by the claims and equivalents thereof.

What is claimed is:

1. An ultrasonic fuel supplying apparatus, comprising:
an ultrasonic fuel tank including a fuel storing space for accommodating a fuel and a fuel atomizing space for accommodating an atomized fuel;
an input pipe for supplying the fuel from an external main fuel tank to the ultrasonic fuel tank;
at least one ultrasonic transducer arranged at a lower portion of the ultrasonic fuel tank and configured to atomize the fuel accommodated in the fuel storing space;
an ultrasonic transducer controller configured to drive the at least one ultrasonic transducer;
an output pipe for supplying atomized fuel from the ultrasonic fuel tank to an external fuel injection unit; and
an output pipe extending unit extended from the output pipe into the fuel atomizing space and including an opening at a distal end.

2. The ultrasonic fuel supplying apparatus according to claim 1, further comprising a fuel level control unit arranged between the input pipe and the ultrasonic fuel tank and configured to maintain a fuel level in the fuel storing space to a constant level.

3. The ultrasonic fuel supplying apparatus according to claim 1, further comprising a fuel control unit configured to control an amount of a fuel supplied directly from the main fuel tank to the fuel injection unit.

4. The ultrasonic fuel supplying apparatus according to claim 1, further comprising an air intake port configured, when a pressure inside the ultrasonic fuel tank is decreased as the atomized fuel is supplied to the fuel injection unit through the output pipe, to open to inject an air into the ultrasonic fuel tank, wherein
the air intake port is arranged at a wall of the ultrasonic fuel tank at a position higher than the opening of the output pipe extending unit.

5. The ultrasonic fuel supplying apparatus according to claim 1, wherein the fuel control unit includes
a valve for controlling amount of the fuel traveling through a fuel supply pipe between the main fuel tank and the fuel injection unit, and
a first valve controller configured to control the valve according to an operation status of an internal combustion engine or a combustion apparatus operated by a fuel injected by the fuel injection unit.

6. The ultrasonic fuel supplying apparatus according to claim 2, wherein the fuel level control unit includes
a fuel gauge configured to detect the fuel level in the fuel storing space,
a fuel level control valve arranged between the input pipe and the ultrasonic fuel tank, and
a second valve controller configured to control an opening amount of the fuel level control valve based on the fuel level in the fuel storing space detected by the fuel gauge.

7. The ultrasonic fuel supplying apparatus according to claim 2, the fuel level control unit includes
a level control fuel tank arranged between the input pipe and the ultrasonic fuel tank and configured to maintain a fuel level same as the fuel level of the ultrasonic fuel tank,
a fuel gauge configured to detect the fuel level of the level control fuel tank,
a fuel level control vale arranged between the input pipe and the level control fuel tank, and
a second valve controller configured to control an opening amount of the fuel level control valve based on the fuel level of the level control fuel tank detected by the fuel gauge.

8. The ultrasonic fuel supplying apparatus according to claim 4, wherein
the air intake port includes
an air inlet formed on a wall of the ultrasonic fuel tank,
a caulking member configured to seal the air inlet from an inside of the ultrasonic fuel tank, and
an elastic member configured to provide an elastic force to cause the caulking member to seal the air inlet,
when the pressure inside the ultrasonic fuel tank is a normal pressure, the caulking member is configured to seal the air inlet by the elastic force of the elastic member, and
when the pressure inside the ultrasonic fuel tank is decreased below the normal pressure such that an internal contractile force exceeds the elastic force of the elastic member, the caulking member is configured to be pulled inward to open the air inlet.

9. An internal combustion engine, comprising:
a main fuel tank for storing a fuel;
a fuel pump coupled to the main fuel tank;
the ultrasonic fuel supplying apparatus according to claim 1;
a fuel injection unit configured to supply the fuel from the fuel pump and the atomized fuel from the ultrasonic fuel supplying apparatus to a cylinder chamber; and
a drive unit configured to drive using the fuel supplied by the fuel injection unit.

10. The internal combustion engine according to claim 9, further comprising a fuel control unit configured to control an amount of a fuel supplied directly from the main fuel tank to the fuel injection unit, wherein
in a predetermined revolutions per minute (RPM) region or under a predetermined driving condition, the drive unit is configured to drive using the atomized fuel from the ultrasonic fuel supplying apparatus as a main fuel supply line.

11. The internal combustion engine according to claim 10, wherein, in the main fuel supply line,
a proportion of an amount of a fuel supplied directly from the main fuel tank is equal to or lower than 49% of an amount of a total fuel supplied to the cylinder chamber, and
a proportion of an amount of the atomized fuel supplied from the ultrasonic fuel supplying apparatus is equal to or higher than 51% of the amount of the total fuel supplied to the cylinder chamber.

12. The internal combustion engine according to claim 10, wherein, in the main fuel supply line,
a proportion of an amount of a fuel supplied directly from the main fuel tank is equal to or lower than 19% of an amount of a total fuel supplied to the cylinder chamber, and
a proportion of an amount of the atomized fuel supplied from the ultrasonic fuel supplying apparatus is equal to or higher than 81% of the amount of the total fuel supplied to the cylinder chamber.

13. The internal combustion engine according to claim 10, wherein, in the predetermined RPM region or under the predetermined driving condition, the drive unit is configured to drive only using the atomized fuel supplied from the ultrasonic fuel supplying apparatus.

14. A combustion apparatus, comprising:
a main fuel tank for storing a fuel;
the ultrasonic fuel supplying apparatus according to claim 1;
a fuel injection unit configured to supply the fuel from the main fuel tank and the atomized fuel from the ultrasonic fuel supplying apparatus into a combustion chamber; and
a combusting unit configured to combust the fuel and the atomized fuel supplied by the fuel injection unit in the combustion chamber.

15. The combustion apparatus according to claim 14, further comprising a fuel control unit configured to control an amount of a fuel supplied directly from the main fuel tank to the fuel injection unit, wherein
under a predetermined operating condition, the fuel injection unit is configured to supply the atomized fuel from the ultrasonic fuel supplying apparatus into the combustion chamber as a main fuel supply line.

16. The combustion apparatus according to claim 15, wherein, in the main fuel supply line,
a proportion of an amount of a fuel supplied directly from the main fuel tank is equal to or lower than 49% of an amount of a total fuel supplied to the combustion chamber, and
a proportion of an amount of the atomized fuel supplied from the ultrasonic fuel supplying apparatus is equal to or higher than 51% of the amount of the total fuel supplied to the combustion chamber.

17. The combustion apparatus according to claim 15, wherein, in the main fuel supply line,
a proportion of an amount of a fuel supplied directly from the main fuel tank is equal to or lower than 19% of an amount of a total fuel supplied to the combustion chamber, and
a proportion of an amount of the atomized fuel supplied from the ultrasonic fuel supplying apparatus is equal to or higher than 81% of the amount of the total fuel supplied to the combustion chamber.

18. The combustion apparatus according to claim 15, wherein, under the predetermined driving condition, the fuel injection unit is configured to supply only the atomized fuel from the ultrasonic fuel supplying apparatus into the combustion chamber.
